(19) United States
(12) Patent Application Publication
(10) Pub. No.: US 2012/0250533 A1
(43) Pub. Date: Oct. 4, 2012

(54) SYMMETRIZATION OF CHANNEL IMPULSE RESPONSE

(76) Inventor: Tom Harel, Shfaim (IL)

(21) Appl. No.: 13/075,119

(22) Filed: Mar. 29, 2011

(51) Int. Cl. H04B 17/00; H04L 12/26

(52) U.S. Cl. 370/252; 375/224

(57) ABSTRACT

Embodiments of apparatuses, articles, logic, methods, and systems for a multi-carrier receiver that makes symmetric a channel impulse response to reduce channel estimation computational complexity are generally described herein. Other embodiments may be described and claimed.

### FIELD

Embodiments of the present invention relate generally to the field of multi-carrier communications, and more particularly, to a multi-carrier receiver that makes symmetric a channel impulse response to reduce channel estimation computational complexity.

### BACKGROUND

In most orthogonal frequency division multiplex (OFDM) designs, a transmitter adds a cyclic prefix to a symbol in order to avoid or reduce inter-symbol interference (ISI) due to multipath signal propagation. A receiver, which tries to minimize ISI, will receive a linear combination of cyclically-rotated versions of the original signal. For an ISI-free case, the rotation may be bound to a region between 0 and a length of the cyclic prefix. The cyclic rotation may cause, at an output of a fast Fourier transform (FFT) element (i.e., in the frequency domain), a linear trend with a positive slope of the phase of the channel frequency response.

Channel estimation may be used to predict current channel conditions to enable reliable communication with high data rates. Channel estimation may be based on weighted averages of a frequency response that is sampled on pilot tones, reference signals, preambles, and/or data tones. For example, a common method for channel estimation is a minimum mean-squared error (MMSE) estimation method. In a MMSE estimation method, correlations of a channel in different tones are calculated assuming a flat power delay profile (PDP) over a given range of delay values. This channel estimation is generally robust with respect to different PDP's.

As alluded to above, a receiver's channel impulse response, as seen in the frequency domain by rotated versions, is typically rotated in one direction, or else ISI may be introduced. Therefore, the PDP of such a signal is time shifted, or put another way, not symmetric about zero, which may complicate channel correlations and result in complex-valued coefficients being used in the MMSE estimation method.

Channel estimation using such complex-valued coefficients may be one of the most computationally-intensive operations in a receive chain of an OFDM signal. Complex-by-complex multiplication may involve four real multiplications or alternatively three real multiplications with a high precision. The memory utilized for the coefficients also may be large, especially if the coefficients are selected according to average signal-to-noise ratio, delay spread, and Doppler spread, and when two-dimensional (time frequency) channel estimation is used.

To avoid this, a non-time-shifted delay profile may be chosen in order to have real-valued coefficients. For example, a simple un-weighted average might be used to smooth a preamble signal in various types of wireless signals. However, this may cause a degradation in noise reduction of channel estimation because filters will pass negative delays where actual signal is not present, resulting in unwanted noise.

### BRIEF DESCRIPTION OF THE DRAWINGS

Embodiments are illustrated by way of example and not by way of limitation in the figures of the accompanying drawings, in which like references indicate similar elements.

FIG. 1 illustrates a receive chain that may be used by a receiver to process an incoming signal in accordance with some embodiments.

FIG. 2 illustrates a power delay profile before and after it is shifted, as well as a resulting output of an FFT after shifting.

FIG. 3 illustrates a method of cyclically shifting a symbol within a received signal in order to make the signal's power delay profile symmetric about zero in accordance with some embodiments.

FIG. 4 illustrates a symbol as it may be received and cyclically rotated to yield a symmetric power delay profile, thereby avoiding complex calculations in subsequent channel estimation in accordance with some embodiments.

FIG. 5 illustrates a system that may be configured to process an incoming signal in accordance with some embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “NB” and “A and/or B” mean (A), (B), or (A and B); and the phrase “A, B, and/or C” means (A), (B), (C), (A and B), (A and C), (B and C) or (A, B and C).

As used herein, reference to an “element” may refer to a hardware, a software, and/or a firmware element employed to obtain a desired outcome. Although only a given number of discrete elements may be illustrated and/or described, such elements may nonetheless be represented by additional elements or fewer elements without departing from the spirit and scope of embodiments of this disclosure.

As used herein, a “symbol” is a series of samples. Each sample may have a value, such as 1 or 0, and the combination of samples in a symbol may give the symbol meaning. For example, the ASCII symbol for the letter “A,” which is represented in decimal by the number 65, is represented by the following samples/bits: 1000001.

As used herein, the term “complex coefficient” refers to a number that includes a real and an imaginary part. A “non-complex coefficient” is a number that does not include an imaginary part.

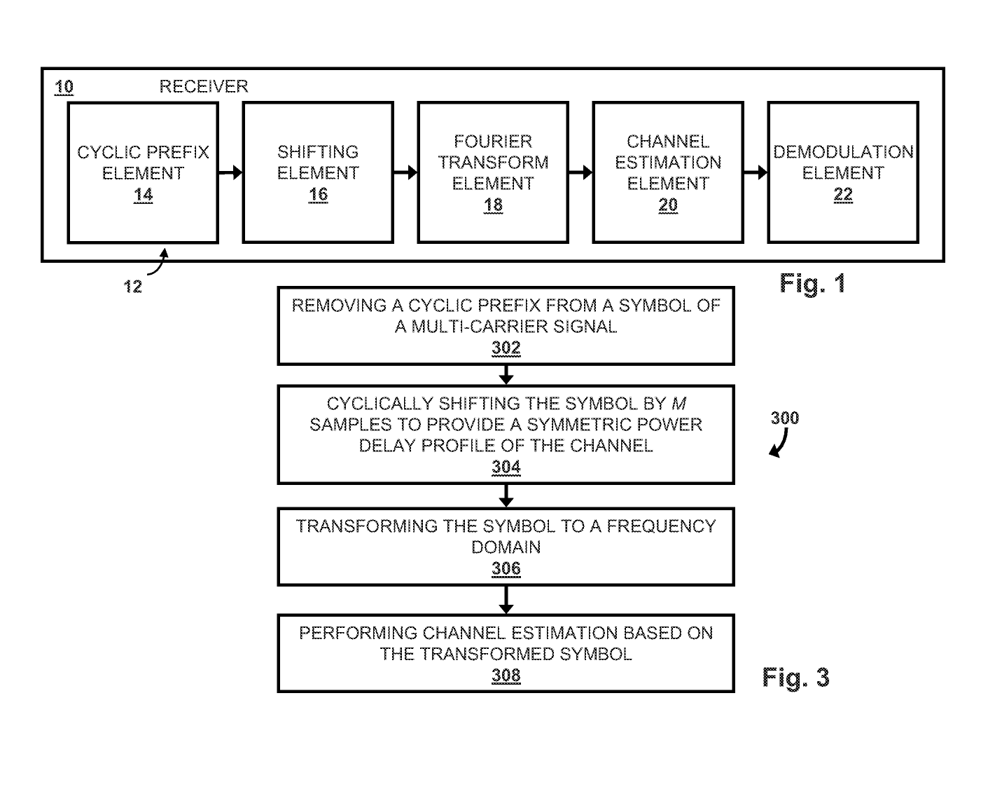

Referring now to FIG. 1, a receiver 10 includes a receive chain 12 for receiving a signal. The receive chain 12 may be utilized in various types of mobile devices to process signals received according to various standards, including but not limited to the Institute of Electrical and Electronics Engineers (“IEEE”) 802.16 standard, IEEE Std 802.16-2009, published May 29, 2009 (“WiMAX”), 3GPP Long Term Evolution (“LTE”), the IEEE 802.11 standard, IEEE Std. 802.11-2007, published Jun. 12, 2007 (“WiFi”) the Digital Video Broadcasting-Handheld standard, ETSI En. 302 304, published November, 2004 (“DVB-H”), and the Digital Video Broadcasting-Terrestrial standard, ETSI En. 300 744, published January, 2009 (“DVB-T”). One or more of the elements shown in FIG. 1 may be implemented in hardware, software, or in a combination of the two.

As noted above, symbols within a received signal may include a cyclic prefix that was inserted by a transmitter to avoid inter-symbol interference due to multipath signal propagation. Thus, receive chain 12 includes a cyclic prefix element 14 to remove a cyclic prefix from a symbol contained in the received signal.

A cyclic prefix may have various lengths depending on various parameters. In many embodiments, the cyclic prefix has a length that is related to a maximum delay spread (i.e. the time difference between the first and the last taps) of a channel. In some cases, the cyclic prefix has a length in samples that is equal to the maximum delay spread time of the power delay profile. Whatever the length of the cyclic prefix, removing it causes the symbol to be rotated so that the power delay profile of the signal is not symmetric about zero. As noted above, this increases the complexity of channel estimation.

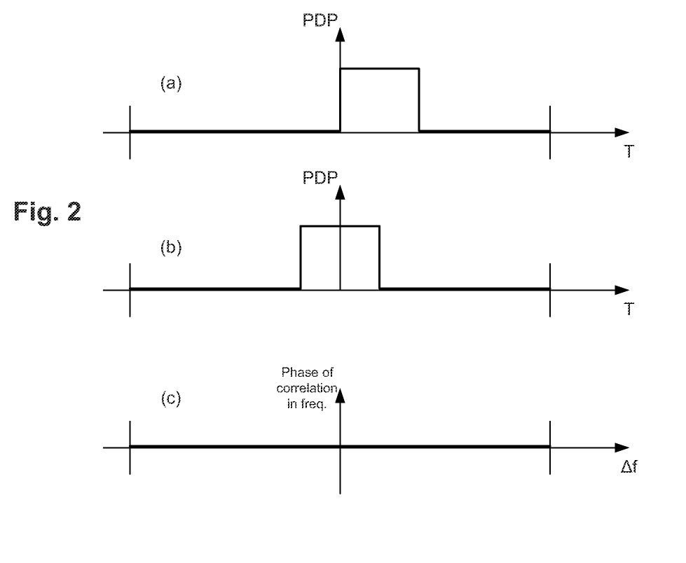

FIG. 2(a) depicts a power delay profile (PDP) of a signal, received at a receiver and time shifted as the result of cyclic prefix removal. As noted above, insertion and removal of the cyclic prefix causes a symbol to be rotated so that the corresponding power delay profile is time shifted, or put another way, not symmetric about zero. An output of an FFT resulting from the power delay profile of FIG. 2(a) may have a linear trend with a positive slope of a phase of a channel frequency response.

Accordingly, the receive chain 12 of FIG. 1 also includes a shifting element 16 that cyclically shifts (e.g., rotates) the symbol by a number of samples, e.g., m samples. The amount of shift m may be dependent on various factors and may be chosen for various reasons. In some embodiments, m is a function of the timing estimation and the channel estimation design. In some embodiments, m may be related to the length of the cyclic prefix. For example, m may be half the length of the cyclic prefix. In other embodiments, m may be related to the maximum delay spread of a power delay profile. For example, m may be the number of samples that add up to a time equal to half the maximum delay spread.

FIG. 2(b) depicts a power delay profile of a signal after it is cyclically shifted in accordance with various embodiments discussed below. The resulting output of an FFT is shown at FIG. 2(c), and is flat, rather than having a positive slope as would the un-shifted signal of FIG. 2(a).

Shifting the symbol by m samples results in a power delay profile of the signal being symmetric about zero, as shown for example in FIG. 2(b). A symmetric power delay profile in the frequency domain, yields non-complex frequency correlations and channel estimation coefficients, which reduces the complexity of channel estimation. Put another way, the shift by m samples cancels the average “timing offset” due to the cyclic prefix. This enables the design of channel estimation based on a symmetric power delay profile with real coefficients. Thus, assuming the following set of samples post-cyclic prefix removal, (x₀, x₁, . . . x_{Nfft-1}), the result of the cyclic shift by m is (x_{Nfft-m}, x_{Nfft-m+1}, x₀, . . . , x_{Nfft-m-1}). This manipulation only changes the order of the samples, without utilizing significant calculation.

A symmetric power delay profile allows for the use of real-valued coefficients in channel estimation. This may reduce the number of multiplications per tone by 50% compared to complex coefficients. Real by complex multiplications may only involve two real multiplications. Additionally, memory size for real coefficients may be 50% less than that for complex coefficients.

After shifting element 16, a Fourier transform element 18 may implement a fast Fourier transform (FFT) algorithm to transform the symbol from a time domain to a frequency domain. The phase of the signal at the output of Fourier transform element 18 may not exhibit a positive slope due to the shift by shifting element 16 as seen, for example, in FIG. 2(c).

After Fourier transform element 18, a channel estimation element 20 may be provided to estimate channel conditions based on the transformed symbol.

In mobile wireless receivers (e.g. WiMAX, LTE and DVB-T) channel estimation may track the channel response, which varies in time and frequency. This may be done by two-dimensional filtering, which means that a channel is estimated from several tones on different symbols (time) and sub-carriers (frequency). The embodiments described herein may be applicable to such a scenario. The time correlations are real, so the two-dimensional coefficients are real if the frequency coefficients are real.

Once the channel conditions are estimated, a demodulation element 22 demodulates the signal into usable data.

FIG. 3 depicts an exemplary method 300 that may be performed by the receive chain 12 in FIG. 1. At 302, a cyclic prefix is removed from a symbol of a multi-carrier signal, e.g., by cyclic prefix element 14 in FIG. 1.

At 304, the symbol is shifted (e.g., by shifting element 16 in FIG. 1) by m samples to provide a symmetric power delay profile. Whatever the length of m, the result is that the power delay profile of the signal is symmetric about zero.

At 306, the shifted symbol is transformed to a frequency domain, e.g., by Fourier transform element 18 of FIG. 1. Because the power delay profile of the signal is symmetric about zero, frequency correlations and MMSE coefficients may be non-complex, reducing the computational complexity of channel estimation.

At 308, channel estimation is performed, e.g., by channel estimation element 20 of FIG. 1. In some embodiments, channel estimation may make use of pilot tones and possibly also data tones. Channel estimation may be based on weighted averaging of a frequency response that may be sampled on, for instance, pilot tones. For example, a receiver may use MMSE analysis where correlations of the channels in different tones are calculated assuming a flat power delay profile over a given range of delay values. This manner of channel estimation may be robust among various different power delay profiles.

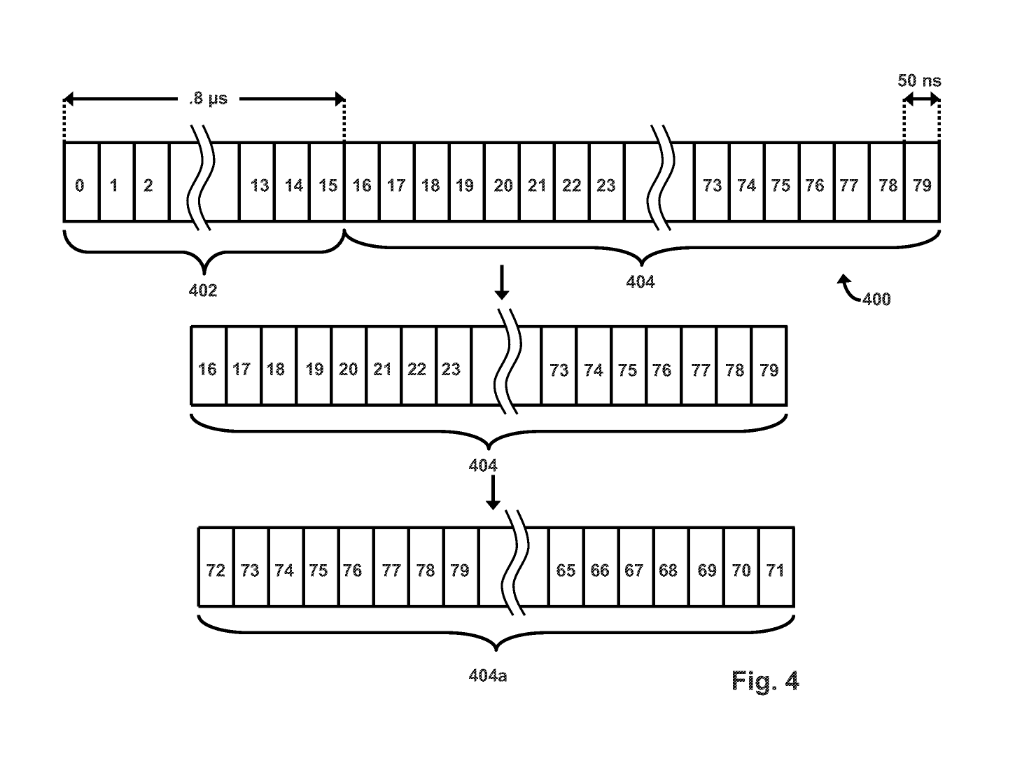

FIG. 4 depicts an exemplary symbol 400 as it may be altered by an orthogonal frequency-division multiplexing (“OFDM”) receiver to reduce channel estimation complexity. In WiFi OFDM (e.g., IEEE 802.11a and IEEE 802.11g), each symbol (e.g., 300) includes a cyclic prefix having a length of 16 samples and a symbol body (i.e., the portion of the symbol after the cyclic prefix that carries actual information) having a length of 64 samples. The sample time is 50 nanoseconds (ns). Therefore, the total symbol length, including the cyclic prefix, is 80 samples, and 4 microseconds (μs) are used to sample a symbol. Assume that the maximum delay spread of the channel equals the length of the cyclic prefix (16×50 ns=0.8 μs).

In FIG. 4, symbol 400 includes cyclic prefix 402 and symbol body 404. Assume a first channel tap occurs at sample 0 and that the last channel tap occurs at sample 16, since the maximum delay spread of the channel is 0.8 μs, or 16 samples. In such a case, the first sample of symbol body 404 coincides with the last channel tap. Accordingly, samples 0-15, which form cyclic prefix 402, may contain a mixture of information from a current symbol body and a previous symbol body (as noted above, a cyclic prefix may be a repetition of the end of a corresponding symbol body).

After symbol 400 is received at a receiver, cyclic prefix 402 (i.e. samples 0 to 15) may be removed (e.g., by cyclic prefix element 14 in FIG. 1 and at 302 of FIG. 3). Traditionally, samples 16-79 would then have been transformed (e.g., by Fourier transform element 18 in FIG. 1) to the frequency domain, to be followed up by channel estimation (e.g., by channel estimation element 20 of FIG. 1), equalization, demodulation (e.g., by demodulation element 22 of FIG. 1) and so forth.

However, as noted above, symbol body 404 (i.e. samples 16-79) as received by the receiver is rotated in one direction due to the removal of cyclic prefix 402. Thus, a power delay profile based on the impulse response of samples 16-79 is not symmetric about zero, which leads to correlations in frequency, provided by a Fourier transform of the power delay profile, being complex. Complex correlations in frequency mean complex channel estimation (e.g., MMSE) coefficients. Performing channel estimation with complex coefficients is, as noted above, computationally expensive.

Accordingly, in order to simplify channel estimation, prior to transforming symbol body 404 from a time domain to a frequency domain (e.g., at 306 of FIG. 3), the samples within are shifted (e.g., by shifting element 16 of FIG. 1 at 304 of FIG. 3) by m=8 samples. Eight is half the length in samples (16) of cyclic prefix 402, and is also equivalent in time to half of the maximum delay spread (0.8 μs). Shifting symbol body 404 by eight samples yields a shifted symbol body 404a. Shifted symbol body 404a has a power delay profile that is symmetric about zero, simplifying subsequent channel estimation computationally.

Although some of the example described herein use WiFi OFDM, it should be understood that disclosed embodiments may be used with other multi-carrier communication technologies, such as WiMAX, LTE, WiFi, DVB-H and so forth, without departing from the scope of the present disclosure.

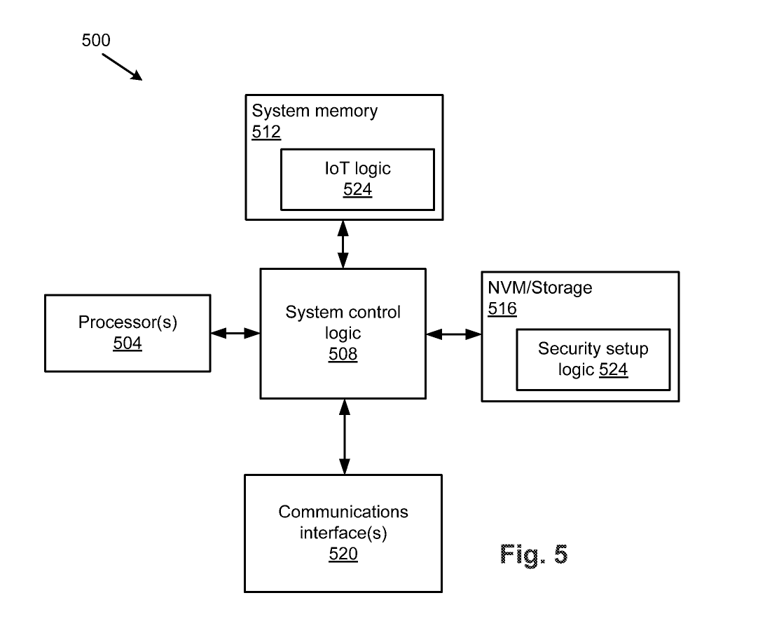

The techniques and apparatuses described herein may be implemented into a system using suitable hardware and/or software to configure as desired. FIG. 5 illustrates, for one embodiment, an example system 500 comprising one or more processor(s) 504, system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for system 500. System memory 512 for one embodiment may include any suitable volatile memory, such as suitable dynamic random access memory (DRAM), for example.

System control logic 508 for one embodiment may include one or more input/output (I/O) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s) for example.

The NVM/storage 516 may include a storage resource physically part of a device on which the system 500 is installed or it may be accessible by, but not necessarily a part of, the device. For example, the NVM/storage 516 may be accessed over a network via the communications interface(s) 520.

System memory 512 and NVM/storage 516 may include, in particular, temporal and persistent copies of receive logic 524, respectively. The receive logic 524 may include instructions that when executed by at least one of the processor(s) 504 result in the system 500 performing receiver operations as described in conjunction with, for example, one or more elements of the receiver 10, such as the shifting element 16 of FIG. 1. In some embodiments, the receive logic 524 may additionally/alternatively be located in the system control logic 508.

Communications interface(s) 520 may provide an interface for system 500 to communicate over one or more network(s) and/or with any other suitable device. Communications interface(s) 520 may include any suitable hardware and/or firmware. Communications interface(s) 520 for one embodiment may include, for example, a wireless network adapter. The communications interface(s) 520 may use one or more antenna(s).

For one embodiment, at least one of the processor(s) 504 may be packaged together with logic for one or more controller(s) of system control logic 508. For one embodiment, at least one of the processor(s) 504 may be packaged together with logic for one or more controllers of system control logic 508 to form a System in Package (SiP). For one embodiment, at least one of the processor(s) 504 may be integrated on the same die with logic for one or more controller(s) of system control logic 508. For one embodiment, at least one of the processor(s) 504 may be integrated on the same die with logic for one or more controller(s) of system control logic 508 to form a System on Chip (SoC).

The system 500 may be a desktop or laptop computer, a mobile telephone, a smart phone, or any other device adapted to receive a wireless communication signal. In various embodiments, system 500 may have more or less components, and/or different architectures.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. A method of receiving a signal, comprising:
removing a cyclic prefix from a symbol of a multicarrier signal received from a channel;
cyclically shifting the symbol by one or more samples to provide a symmetric power delay profile;
transforming the symbol to a frequency domain; and
estimating a condition of the channel based on the transformed symbol.

2. The method of claim 1, wherein said estimation of the channel is performed based on non-complex coefficients.

3. The method of claim 2, wherein the non-complex coefficients are minimum mean square error coefficients.

4. The method of claim 1, wherein the one or more samples is m samples and m is based on a length in samples of the cyclic prefix.

5. The method of claim 1, wherein the one or more samples is m samples and m is one half of a length in samples of the cyclic prefix.

6. The method of claim 1, wherein the one or more samples is m samples and m is based on a maximum delay spread of the channel.

7. The method of claim 6, wherein m is one half of a number of samples of the maximum delay spread of the channel.

8. A receiver, comprising:
a cyclic prefix element to remove a cyclic prefix from a symbol contained in a signal;
a shifting element to shift the symbol by m samples, wherein m is based on a length of the cyclic prefix;
a Fourier transform element to transform the symbol to a frequency domain; and
a channel estimation element to use the transformed symbol to estimate one or more channels.

9. The receiver of claim 8, wherein the channel estimation element uses non-complex coefficients to estimate one or more channels.

10. The receiver of claim 9, wherein the non-complex coefficients are minimum mean square error coefficients.

11. The receiver of claim 8, wherein the shifting element is to shift the symbol to provide a symmetric power delay profile.

12. The receiver of claim 8, wherein m is one half of a length in samples of the cyclic prefix.

13. The receiver of claim 8, wherein m is based on a maximum delay spread of the channel.

14. The receiver of claim 13, wherein m is one half of a number of samples of the maximum delay spread of the channel.

15. A system comprising:
an antenna;
a processor coupled to the antenna; and
a process executable by the processor and configured, upon execution by the processor, to cause the system to:
remove a cyclic prefix from a symbol received from a channel of a multi-carrier signal received at the antenna;
cyclically shift the symbol by m samples to make a power delay profile of the channel symmetric; and
perform channel estimation in the multi-carrier signal.

16. The system of claim 15, wherein the process is configured to cause the system to operate in accordance with an Institute of Electrical and Electronics Engineers 802.11 standard.

17. The system of claim 15, wherein the symbol includes one or more pilot tones.

18. The system of claim 15, wherein the process is configured to cause the system to operate in accordance with an Institute of Electrical and Electronics Engineers 802.16 standard.

19. The system of claim 15, wherein the process is configured to cause the system to operate in accordance with a Digital Video Broadcasting-Handheld standard.

20. The system of claim 15, wherein the process is configured to cause the system to operate in accordance with a 3GG Long Term Evolution standard.
